(19) United States
(12) Patent Application Publication
(10) Pub. No.: US 2005/0106745 A1
(43) Pub. Date: May 19, 2005

(54) Combination of solubility and membrane permeability measurement methods for profiling of chemical compounds

(75) Inventors: David Wexler, San Francisco, CA (US); Shu-Gui Huang, Fremont, CA (US)

Correspondence Address: BOZICEVIC, FIELD & FRANCIS LLP, 1900 UNIVERSITY AVENUE, SUITE 200, EAST PALO ALTO, CA, 94303, US

(73) Assignee: AGY Therapeutics, Inc.

(21) Appl. No.: 10/943,686

(22) Filed: Sep. 17, 2004

Related U.S. Application Data
(60) Provisional application No. 60/504,153, filed on Sep. 19, 2003.

(51) Int. Cl. G01N 21/75

(52) U.S. Cl. 436/164

(57) ABSTRACT

Compound solubility and permeability are coordinately determined. High throughput solubility assays are set up, and the filtrate from the solubility assay is used as an input for PAMPA. In this way, the compound concentration during PAMPA is known exactly, and can be used as input to calculate Pe.

### BACKGROUND OF THE INVENTION

Pharmaceutical drug discovery is a multi-billion dollar industry. A great deal of effort has been expended on the identification and validation of therapeutic targets, as well as the identification of lead compounds. Although the rewards for identification of a useful drug are enormous, but the percentages of hits from any screening program are generally very low. Desirable compound screening methods solve this problem by both allowing for a high throughput method so that many individual compounds can be tested; and by providing good characterization of compounds, so that there is a good correlation between the information generated by the screening assay and the pharmaceutical usefulness of the compound.

With an ever increasing pressure to push compounds through the drug discovery pipeline, there is a steady demand for reliable, high throughput assay technologies in ‘bottle neck’ areas. One ‘bottle neck’ area that has received significant attention lately is ADME-Tox (Adsorption, Distribution, Metabolism, Excretion, and Toxicology). The pressure is compounded by an association of some late stage drug failures with poor pharmacokinetic properties, such as low oral absorption.

To minimize these late stage failures, it is valuable to screen compounds for physicochemical parameters involved in absorption at an early stage of drug discovery. These parameters include solubility, which is the maximum concentration that a molecule can present to the solution. Regardless how potent a compound is, if it is not soluble, then its concentration at the target will be negligible. Another parameter is membrane permeability, which is a quantitative description of how quickly molecules can cross membrane barriers.

Methods that can deliver data related to membrane permeation for large numbers of compounds at an early stage of the discovery/development process are particularly useful. For example, parallel artificial membrane permeation assays (PAMPA) use a hydrophobic filter material as a support to analyze the permeation of compounds through a membrane formed by a mixture of lecithin and an inert organic solvent. PAMPA is based on a 96-well microtiter plate technology, with pores and passive transporter systems. Concentrations of compounds are determined by simultaneous UV measurements at different wavelengths using a 96-well microplate photometer. A reference solution defining equilibrium conditions is used as an internal standard. Permeation of the membrane layer is strongly dependent on the pH; and generally a range of pH values is considered.

Determination of aqueous solubility in a high-throughput screening environment plays an important role in the selection of drug candidates. Methods in current use involve the determination of solubility by measuring the UV spectrum of a reference solution of the compound, under conditions avoiding or suppressing precipitation, and comparing it to the UV spectrum of a saturated sample solution of the compound.

High throughput screening methods are of interest for the development of new drugs, and for assessing enzyme activity in various clinical and research settings. Improvements in such methods allow for better evaluation of drug candidates. The present invention addresses this issue.

### PUBLICATIONS

Methods of determining compound solubility are described in U.S. Pat. Nos. 4,127,687; 4,906,580; 5,192,509; 5,677,286; 5,750,678; 6,004,822; 6,271,038. Methods of determining compound solubility are described in International Application US03/02095. The initial article describing parallel artificial membrane permeation assays (PAMPA) may be found in Kansy et al. (1998) J. Med. Chem. 41:1007-1007-1010.

### SUMMARY OF THE INVENTION

Methods are provided for the combined determination of solubility and permeability of a compound, where the permeability assay is performed using aqueous compound solutions at maximum solubility. High throughput solubility assays are set up, and the filtrate from the solubility assay is used as an input for permeability screening, e.g. PAMPA. In this way, the compound concentration during the permeability assay is known exactly, and can be used as input to calculate Pₑ. Also, by avoiding compound precipitation in the permeability donor wells, overestimation of the membrane retention is avoided. Compounds are also more easily tracked, and data analysis can be simultaneously performed for both assays.

The combination of solubility and permeability assays also provides operational and experimental benefits. The throughput is increased by reducing the total number of aqueous solutions that are created as inputs. This, in turn, reduces the number of freeze-thaw cycles that the compounds undergo and thus reduces degradation.

In one embodiment of the invention, increased sensitivity is obtained by transferring samples to small wells, e.g. in plates comprising 384 wells or greater than 384 wells. Where the sample is held at a constant volume, the smaller well size provides an increased pathlength for light, and therefore improved sensitivity.

### BRIEF DESCRIPTION OF THE DRAWINGS

FIGS. 1A and 1B: Process flow chart for the combined solubility and permeability assays. The automated liquid handling steps are indicated in the flow chart by the name of the instrument within the solid arrows. The vacuum filtration step in 1A) is also performed by the Biomek FX 96 liquid handling system. a) Solubility portion of the process flow starting with 1.5 mL centrifuge tubes and phosphate buffers at pH values: 3, 5, 7.4, and 9. Samples are shaken in 96-deepwell plates for 1.5 hours, vacuum filtered and collected. One aliquot of the filtrate solutions is used for UV spectral measurement in 384-well plates and calculation of solubility and the remaining volume is used as input to the permeability assay. 1B) Permeability portion of the process flow. Membrane solutions are added to the acceptor/filter plate, the donor/acceptor complex is then formed and incubated at room temperature. After 16 hours, the donor/acceptor complex is then separated and aliquots from the donor, acceptor, and 96-deepwell filtrate plate are placed into a 384-well UV plate for spectral measurement and Pₑ calculation.

FIG. 2A-2B: Effective permeability (Pₑ) plotted for 8 control compounds comparing two input solution concentrations, solubility limit of each compound and 100 μM. Data is displayed for two different membrane models: a) GIT model and b) BBB model. The error bars are the standard deviations calculated from n=5 experiments.

FIG. 3A-3H: Effective permeability (Pₑ) plotted versus input concentration. Input concentrations for the 8 compounds (a-h) were serial diluted 1:2 starting with 350 μM. The error bars are the standard deviations calculated from n=5 experiments.

FIG. 4: Effective permeability (Pₑ) plotted versus well number. 96 replicates of a single compound were run on each assay plate. The data from three replicate plates of verapamil and theophylline each is displayed.

### DETAILED DESCRIPTION OF THE EMBODIMENTS

Before the present methods are described, it is to be understood that this invention is not limited to particular methods described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges, subject to any specifically excluded limit in the stated range.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

The method involves determining solubility of a compound by measuring the UV spectrum of a reference solution of the compound, under conditions avoiding or suppressing precipitation, and comparing it to the UV spectrum of a saturated sample solution of the compound. The reference solution is established by dilution of the sample solution to the point where precipitation is avoided.

Methods are provided for the combined determination of solubility and permeability of a compound. The method allows for high throughput analysis of multiple samples, for example, multiple potential drugs or therapeutic agents to be tested in a method of drug discovery. The high throughput assay utilizes a plurality of spatially discrete regions, which can be termed test regions and which can be wells. Multiple plates are set up, corresponding to the different assays. Each test region defines a space for the introduction of a sample containing (or potentially containing) one or more compounds of interest.

Solubility is determined in a parallel detection method, based on the use of multiwell plates for making concentrations of test compounds under conditions avoiding or suppressing precipitation, and measured by a suitable spectroscopic method. For example, the plates may be read with a UV/visible spectrophotometer. Compound-dependent method optimization is not required in the direct UV method. Concentration standards may be made in aqueous solvents; and/or in the presence of non-aqueous solvents, e.g. DMSO, methanol, etc. The UV spectroscopic properties need not be defined at the start of the assay. The concentration of the compound in the solvent is determined by identifying the OD at an appropriate wavelength from spectra that have been heuristically matched, scaled and appropriately baseline corrected, matching OD of reference solutions (of known concentration, under conditions avoiding or suppressing precipitation) to solutions containing an analyte of unknown concentration (due to precipitation).

The filtrate from the solubility assay is used as an input for the permeability assay (PAMPA). In this way, the compound concentration during PAMPA is known exactly, and can be used as input to calculate Pₑ. Also, by avoiding compound precipitation in the PAMPA donor wells, overestimation of the membrane retention is avoided. Compounds are also more easily tracked, and data analysis can be simultaneously performed for both assays.

The methods of the present invention improve the process flow and data quality in the determination of aqueous solubility and membrane permeability (physicochemical compound profiling). Benefits include improved efficiency in laboratory operations and sample throughput; reduced consumption of raw compound material; greater sensitivity in UV/Vis measurement; and reduced potential error in membrane retention calculation due to precipitation.

Permeability assays may be customized for membranes of interest, by varying the components of the lipid phase doped onto the filter plate; of the donor compartment, and of the acceptor compartment. Specific assays of interest include a gastrointestinal tract (GIT) model; and a blood brain barrier (BBB) model.

The GIT model utilizes an in vitro artificial membrane composed of phospholipid dissolved in organic solvent. The membrane comprises egg lecithin dissolved in n-dodecane. This Pₑ values obtained via this model can be used to predict human jejunal permeability. Useful phospholipids include phosphatidylcholine (PC), phosphatidylethanolamine (PE), phosphatidylserine (PS), phosphatidicacid, phosphatidylinositol (PI), phosphatidylglycerol (PG), and sphingomyelin. The concentration of egg lecithin may be from about 1 to 20% mass/volume of the membrane composition.

The BBB model utilizes an in vitro artificial membrane composed of phospholipid dissolved in organic solvent to predict brain penetration of candidate drug molecules. The membrane may comprise brain lipid extract dissolved in n-dodecane. This Pₑ values obtained via this model can be used to predict central nervous system active compounds. Polar lipid extract is the total lipid extract precipitated with acetone and then extracted with diethyl ether. Total Lipid Extract is a chloroform:methanol extract of brain tissue, usually mammalian brain tissue, e.g. porcine, human, rat, etc. This extract is partitioned against deionized water, and the chloroform phase is concentrated. Exemplary components of the polar extract are as follows: Phosphatidylethanolamine 33.1%/Wt, Phosphatidylserine 18.5%/Wt, Phosphatidylcholine 12.6%/Wt, Phosphatidic Acid 0.8%/Wt, Phosphatidylinositol 4.1%/Wt, Other 30.9%/Wt.

Any compatible substrate surface that is transparent to UV/Vis light can be used in conjunction with this invention. The surface can be any of a variety of organic or inorganic materials or combinations thereof, including, merely by way of example, plastics such as polypropylene or polystyrene; silicon; (fused) silica, quartz or glass. In a preferred embodiment, the surface is the plastic surface of a multiwell plate, e.g., tissue culture dish, for example a 24-, 96-, 256-, 384-, 864- or 1536-well plate. The shape of the surface is not critical. It can, for example, be a flat surface such as a square, rectangle, or circle; a curved surface; and the like. Alternatively, a surface such as a glass surface can be etched out to have, for example, 864 or 1536 discrete, shallow wells. Alternatively, a surface can comprise regions with no separations or wells, for example a flat surface, e.g. piece of plastic or glass with individual regions that are defined by overlaying a structure that delineates the separate regions. In another embodiment, the regions can be defined as tubes or fluid control channels, e.g., designed for flow-through assays, as disclosed, for example, in Beattie et al (1995). Clin. Chem. 4:700-706. Tubes can be of any size, e.g., capillaries or wider bore tubes. The relative orientation of the test regions can take any of a variety of forms including, but not limited to, parallel or perpendicular arrays within a square or rectangular or other surface, radially extending arrays within a circular or other surface, or linear arrays, etc.

Each of the assays or procedures described below can be performed in a high throughput manner, in which a large number of samples (e.g., as many as about 864, 1036, 1536, 2025 or more) are assayed on each plate or surface rapidly and concurrently. Further, many plates or surfaces can be processed at one time. For example, in methods of drug discovery, a large number of samples, each comprising a drug candidate (e.g., a member of a combinatorial chemistry library, such as variants of small molecules, peptides, oligonucleotides, or other substances), can be added to separate wells; and assays can be performed on each of the samples. With the recent advent and continuing development of high-density microplates, robotics, improved dispensers, sophisticated detection systems and data-management software, the methods of this invention can be used to screen or analyze thousands or tens of thousands or more of compounds per day. Measurement of permeability can also be achieved by HPLC; LC/MS; and the like.

### Solubility Assay

The term solubility is used herein to mean the concentration of a solute (in units of moles per liter, M, or micrograms per milliliter, μg/ml) in a saturated pH-buffered aqueous solution. Under pH conditions where the sample molecule is essentially uncharged, the measured solubility is equal to the intrinsic solubility of the molecule. Solubility may depend on pH, but the intrinsic solubility, being a thermodynamic equilibrium constant, does not. Excipients are additives in a solution that may affect the solubility of the solute. The apparent pKa may vary from the true aqueous value when solutions contain excipients, such as DMSO, propanol, surfactants, bile acids, lipophilic counterions, cyclodextrins, and the like, that can affect the ionization properties of the compound.

The term “stock” solution refers to a solution made from a precisely known quantity of pure compound dissolved in a known volume of solvent, usually pure DMSO, usually at a 10-100 mM concentration level. Compounds are expected to be fully dissolved in the stock solution. A reference is a solution of the sample compound where the concentration of the compound is known. The reference solution can be prepared by precisely weighing a quantity of the pure compound and dissolving it in a precise volume of solvent, usually aqueous solvent, or by adding a precise volume of a stock solution of the compound to a precise volume of solvent under conditions avoiding or suppressing precipitation. Methods that avoid precipitation include the use of aqueous solutions below the limits of solubility; the addition of water-miscible cosolvent to an otherwise saturated aqueous solution; and the like.

A “saturated” solution is at equilibrium. A portion of the compound will be precipitated out of solution, and a portion remains dissolved at a concentration equal to the solubility. To cause the formation of a saturated solution, a small aliquot of the stock solution (typically 1-50 μL) or a weighed quantity of compound is added to an aqueous buffer solution (typically 1000-2000 μL), which is called the “system solution” here. Filtration refers to the separation of a precipitated solid from a saturated solution, either by passing said solution through a filter, by sedimentation, by centrifugation, or by any other separation means. A “filtrate” of a saturated solution comprises only the portion of the compound that is dissolved.

A “supersaturated” contains no solid and comprises more dissolved compound than expected from its equilibrium solubility. Usually, such solutions are unstable, and will precipitate over time.

Aqueous dilution is used to prepare a plate of sample reference solutions for UV measurements. A known quantity of sample is added to a known volume of universal buffer solution at a known pH, in an amount sufficient to cause precipitation in a saturated solution. The saturated solution is allowed to reach steady state, and the solution filtered to remove the solid. The filtrate is then split into at least two aliquots, (A) for the permeability assay; and (B) spectral measurement by UV spectrophotometer.

The UV-Visible spectra can be analyzed by a software program. For example, from the spectrum of each well a heuristically matched, scaled and appropriately shifted baseline can be subtracted. The locations (λ) and the values of all the peaks [OD(λ)] are then determined. OD values larger than 4, and smaller than 0.05 may be ignored. Such programs correctly identify the best OD values in most cases. In addition, built in user interface tools can offer a convenient way to review and manually reassign the λ values to address special cases. When no peaks were found in the spectra, the OD values @ 265 nm may be used.

A reference spectrum is determined by dissolving a known quantity of sample in a known volume of the universal buffer solution of known pH, where the amount of the sample is sufficiently low that precipitation is avoided in the formed solution. The spectrum is immediately taken by the UV spectrophotometer. The mathematical treatment of the spectral data yields OD(λ) of the reference sample solution.

In a cosolvent method, a saturated solution and filtrate thereof is obtained by the method described above. A volume of a water-miscible cosolvent is added to a volume of the filtrate, in order to produce a new solution, in which the compound is diluted from its concentration in the filtrate. The spectrum of the cosolvent solution is then immediately taken by the UV spectrophotometer. The mathematical treatment of the spectral data may be performed as previously described in section [35] and yields the OD(X) of the cosolvent sample solution.

Suitable cosolvents may be selected from a number of water-miscible organic solvents, such as acetonitrile, methanol, ethanol, iso-propanol, 1-propanol, ethylene glycol, propylene glycol, polyethylene glycol 400 (PEG-400), 1,4-dioxane, dimethylformamide, acetone, tetrahydrofuran, dimethyl-sulfoxide (DMSO), and mixtures thereof.

A cosolvent reference spectrum is determined by adding a known quantity of sample to a known volume of the universal buffer solution of known pH, with no effort being made in this step to suppress precipitation in the formed solution. A volume of a water-miscible cosolvent is added to the solution to produce a new solution. The UV spectrum is then immediately measured by the UV spectrophotometer. The mathematical treatment of the spectral data yields the OD(λ) of the cosolvent reference solution.

All the measured absorbances, OD(λ), from each plate well may be used in the analysis. Since the concentration of the reference species is known, the analysis uses that information to assess the unknown concentration of the sample in the filtrate, by applying Beer's law.

### Permeability Assay

The permeability assay is performed essentially as described by Kansy et al. (1998) J. Biol. Chem. 41:1007-1010, herein specifically incorporated by reference), with the improvement that the assay is performed in conjunction with a solubility determination, as described above, using the filtrate from an aqueous, saturated solution. By using the filtrate, each individual compound is used at a saturated, known concentration; where precipitation is minimized.

At the start, the filtrate from the solubility assay is placed into a donor well of a multiwell plate, which typically contains a universal buffer solution at a pre-determined pH, usually pH 5 to pH 7. The initial donor sample concentration is known from the solubility assay, and the concentration is substantially identical to saturation concentration of the sample. A hydrophobic filter plate, e.g. Millipore Immobilon-P (cat# MAIPN4510), having wells corresponding on a one to one basis with the donor wells.

The hydrophobic filter forms the bottom of an acceptor well in a microtiter plate. A quantity of phospholipid solution is deposited on the microfilters. Suitable phospholipids are known in the art, and may include phospholipids such as phosphatidylcholine (PC), phosphatidylethanolamine (PE), phosphatidylserine(PS), phosphatidicacid, phosphatidylinositol (PI), phosphatidylglycerol (PG), and sphingomyelin, where the two hydrocarbon chains are typically between about 14-22 carbon atoms in length, and have varying degrees of unsaturation. Other suitable lipids include glycolipids and sterols such as cholesterol. Diacyl-chain lipids suitable for use in the present invention include diacyl glycerol, phosphatidyl ethanolamine (PE) and phosphatidylglycerol (PG). These lipids and phospholipids can be obtained commercially or prepared according to published methods. The phospholipids may be used in various combinations, depending on the purpose of the invention, and may include defined combinations, naturally occurring combinations, e.g. lipids extracted from brain tissue, and the like. The membrane layer may also comprise non-lipid components, e.g. proteins, fluorescent compounds, etc.

The lipids are provided in a suitable solvent, at a concentration of from about 1 to about 75%. Suitable solvents include n-dodecane, 1-9 decadoene, 1,7-octadiene, 1,6-heptadiene, 1,8-nonadiene; and the like.

An acceptor buffer is placed in the top well, above the synthetic membrane. The acceptor buffer will be substantially free of the test compound, thereby establishing a “sink” condition. In some embodiments of the invention, the acceptor buffer is of a pH that differs from the donor solution. For example, in modeling the dynamics of gastrointestinal permeability, it may be desirable to have the donor solution at a low pH, and the acceptor solution at a neutral pH.

The permeation is allowed to proceed for a period of time sufficient to measure any low permeability compounds, which on average is 16 hours, usually at least about 3 hours and not more than about 24 hours. The final acceptor and donor concentrations are determined by UV spectrophotometry. Mathematical manipulation of the values for determination of permeability are performed as described in U.S. patent application Ser. No. 20030165813; or International Patent Application US0302095, both herein specifically incorporated by reference for this purpose.

### Compound Screening

The methods of the invention are useful in screening compounds, e.g. pharmaceutical candidate compounds, for physiologically relevant parameters. Candidate agents encompass numerous chemical classes, though typically they are organic molecules, preferably small organic compounds having a molecular weight of more than 50 and less than about 2,500 daltons. Candidate agents comprise functional groups necessary for structural interaction with proteins, particularly hydrogen bonding, and typically include at least an amine, carbonyl, hydroxyl or carboxyl group, preferably at least two of the functional chemical groups. The candidate agents often comprise cyclical carbon or heterocyclic structures and/or aromatic or polyaromatic structures substituted with one or more of the above functional groups. Candidate agents are also found among biomolecules including peptides, saccharides, fatty acids, steroids, purines, pyrimidines, derivatives, structural analogs or combinations thereof.

Candidate agents are obtained from a wide variety of sources including libraries of synthetic or natural compounds. For example, numerous means are available for random and directed synthesis of a wide variety of organic compounds and biomolecules, including expression of randomized oligonucleotides and oligopeptides. Alternatively, libraries of natural compounds in the form of bacterial, fungal, plant and animal extracts are available or readily produced. Additionally, natural or synthetically produced libraries and compounds are readily modified through conventional chemical, physical and biochemical means, and may be used to produce combinatorial libraries. Known pharmacological agents may be subjected to directed or random chemical modifications, such as acylation, alkylation, esterification, amidification, etc. to produce structural analogs. Test agents can be obtained from libraries, such as natural product libraries or combinatorial libraries, for example. A number of different types of combinatorial libraries and methods for preparing such libraries have been described, including for example, PCT publications WO 93/06121, WO 95/12608, WO 95/35503, WO 94/08051 and WO 95/30642, each of which is incorporated herein by reference.

Reagents that improve the efficiency of the assay, such as protease inhibitors, nuclease inhibitors, anti-microbial agents, etc. may be used. The components are added in any order that provides for the requisite activity. Incubations are performed at any suitable temperature, typically between 4 and 40° C.

In performing the assays, a software program may be utilized for calculations of permeability and solubility, display of data in graphic and in report forms; for controlling the actions of a robotic fluidic delivery system; controlling the actions of the spectrophotometer and the like.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Experimental

Materials And Methods

Materials. A 45 mM, constant ionic strength (150 mM) phosphate buffering system at 4 pH values was used in both solubility and permeability assays. The commercial drugs: amitriptyline (A-8404), caffeine (C-0750), carbamazepine (C-4024), clonidine (C-7897), diclofenac (D-6899), dextrophan (D-127), desipramine (D-3900), n-dodecane (D-4259), fluvoxamine (F-2802), isoxicam (I-1762), lomafloxacin (L-2906), MK 801 (M-107), phenazopyridine (P-8420), N-tert-Butyl-alpha-phenylnitrone (180270), piroxicam (P-0847), s-propranolol (P-8688), N-methyl-quipazine dimaleate (Q-107), ranitidine (R-101), SKF 95282 (S-5317), SR 57227A (S-1688), theophylline (T-1633), and verapamil (V-4629) were purchased from Sigma Chemical Co. (St. Louis, Mo.). DMSO was reagent grade from Burdick & Jackson (Muskege, Mich.). The porcine brain polar lipid (141101P) was purchased from Avanti Polar Lipids (Alabaster, Ala.) and the egg lecithin (P-3556) was purchased from Sigma Chemical Co. (St. Louis, Mo.). The dodecane was minimum 99% by GC from TCI America (Portland, Oreg.)

Solubility

The method of solubility determination described here is a modified version of the Direct UV method described by Avdeef: High throughput measurements of solubility profiles, in Testa B, van de Waterbeemd H, Folkers G, Guy R (ed) Pharmacokinetics Optimization in Drug Research, Zurich, Switzerland: Verlag Helvitica Chimica Acta; 2001; 305-326.

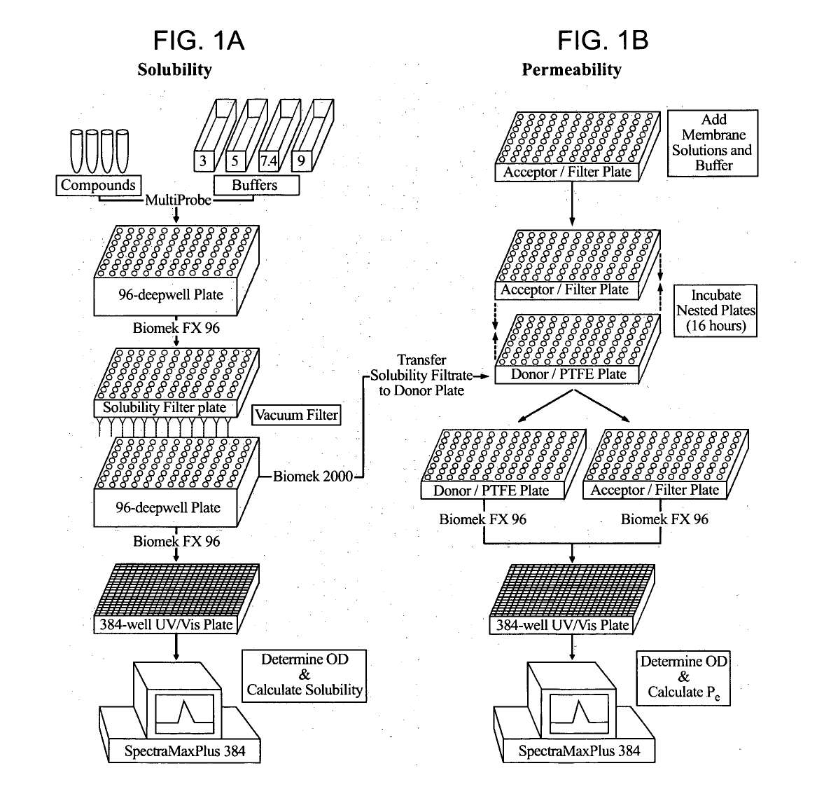

A flow chart of the assay scheme is given in FIG. 1a. A MultiProbell HT liquid handling system was used to setup the solubility experiments. 35 mM compound stock solutions in DMSO were transferred from 1.5 mL centrifuge tubes into 96-deepwell plates (267006, Beckman Coulter, Fullerton, Calif.) containing aqueous buffer solutions of 4 different pH values (3, 5, 7.4, 9). To ensure complete solubility of the compound in the reference wells methanol was added as a co-solvent at 20% v/v. The final concentration of the sample solutions were 350 μM and the reference solutions were 35 mM, both with 1% DMSO content. The aqueous and aqueous/methanol solutions were shaken for 90 minutes at room temperature. Using a 96-tip Biomek FX liquid handling system (Beckman Coulter, Fullterton, Calif.), the solutions were transferred to a MultiScreen-Solubility 96-well filterplate (MSSLBPC10, Millipore, Mass.), vacuum filtered, and collected into a clean 96-deepwell plate. 75 μL of reference filtrate and 60 μL of the sample filtrate was then pipetted using the 96-tip Biomek FX to a 384-well UV/Vis plate (3675, Corning, Corning, N.Y.) for analysis. The sample wells were diluted in the UV/Vis plate with pre-dispensed methanol (20% v/v) for spectroscopic consistency. The remaining portion of the filtrate was sealed and kept in a cool, dark place to be used within 2 hours in the permeability assay. The UV spectrum of each well was measured using a SpectraMaxPlus384 microtiter plate reader (Molecular Devices, Sunnyvale, Calif.) between 250 and 550 nm at 10 nm intervals. The absorption spectra were then corrected for variance in path length by the PathCheck™ algorithm in the SoftMaxPro® software. Next, the optical density (OD) at an appropriate wavelength (λ) was determined for each compound by the analysis algorithm as follows: the UV-Visible spectra were analyzed with a program written in HPBASIC for Windows (TransEra Corporation, Orem, Utah). Briefly, from the spectrum of each well a heuristically matched, scaled and appropriately shifted baseline was subtracted. The locations (λ) and the values of all the peaks [OD(λ)] were then determined. OD values larger than 4, and smaller than 0.05 were ignored. The program correctly identified the best OD values in most cases. In addition, built in user interface tools offered a convenient way to review and manually reassign the λ values to address special cases. When no peaks were found in the spectra, the OD values at 265 nm were used.

For the solubility calculation, a consensus λ was determined for the sample and reference spectra and the corresponding OD values were used in equation (1). The concentrations of the compounds in solution were determined by the following formula:

$$Solubility = \frac{{OD ( λ )}_{Sample}}{{OD ( λ )}_{Reference}} \times [ Reference ] \qquad ( 1 )$$

where OD(λ)sample and OD(λ)_{Reference} are the optical densities at a given wavelength for each compound and [Reference] is the same compound at a known reference concentration.

For the solubility portion of the screen, the compounds are quantitatively assessed in the range of 0 to 350 μM. A compound is determined to have a solubility of <35 μM, if that compound is completely soluble in the co-solvent mixture (80% buffer, 20% methanol) but not soluble in 100% buffer. However, if the true compound solubility is greater than 350 μM it is assigned a value of ‘>350.’ Setting the sample concentration to 350 μM (corresponding to ˜100 mg/L w/v concentration based on the average molecular weight of 350 of the compounds in our library) affords the determination of the solubility values in the range of >10 mg/L amenable for drug candidates.

Permeability

The PAMPA method for permeability determination employed here is similar to that described by Kansey et al. (1998) J Med Chem 41:1007-1010; and Di et al. (2003) Eur J Med Chem 38:223-232. As indicated by the flow chart in FIG. 1b, the input solutions to the permeability screen are directly from the solubility assay. Using a Biomek 2000 liquid handling system (Beckman Coulter, Fullerton, Calif.), 290 μL of the solubility filtrate was transferred to the PTFE donor plate (MSSACCEPTOR, Millipore, Mass.). The filter membrane in the wells of the acceptor plate was coated with 5 μL of 20 mg/mL of the appropriate phospholipid in dodecane and then the wells were filled with 150 μL of pH 7.4 buffer using a 96-tip Biomek FX. Egg lecithin and porcine brain polar lipid (PBL) were used for the GIT and BBB membranes, respectively. The filter acceptor plate was then carefully placed on top of the PTFE donor plate to initiate the permeation process. The plate complex was allowed to incubate for 16 hours at room temperature in a humidity controlled environment. The acceptor plate was carefully removed and then 75 μL from the acceptor plate, donor plate, and solubility filtrate plate (Mass Balance) was transferred to a 384-well UV/Vis plate for analysis.

The UV spectrum of each well was measured using a SpectraMaxPlus384 microtiter plate reader (Molecular Devices, Sunnyvale, Calif.) between 250 and 550 nm at 10 nm intervals. The absorption spectra were then corrected for variance in pathlength by the PathCheck™ algorithm in the SoftMaxPro® software.

The optical density (OD) at the optimal absorption wavelength (λ) was determined for each well. For the Pₑ calculation, a consensus λ value was determined for the donor-, acceptor-, and the “Mass Balance”-wells, and the corresponding OD values were used in equations (2a & 2b). A compound can be given a solubility of less that 35 μM, if that compound is completely soluble in the co-solvent mixture (80% buffer, 20% methanol) but not soluble at 100% buffer. The effective permeability (Pₑ) of each compound was calculated using the following equations:

$$\begin{matrix}{P}_{e} = ( \frac{{V}_{D} \times {V}_{A}}{( {V}_{D} + {V}_{A} ) \times Area \times time} ) \times ln ( 1 - \frac{{[ drug ]}_{A}}{{[ drug ]}_{Eq} \times ( 1 - R )} ) & ( 2 a ) \\ where & \\ R = \frac{( {V}_{A} + {V}_{D} + {V}_{mem} ) \times {OD}_{MassBalance} - {V}_{A} \times {OD}_{A} - {V}_{D} \times {OD}_{D}}{( {V}_{A} + {V}_{D} + {V}_{mem} ) \times {OD}_{MassBalance}} , & ( 2 b )\end{matrix}$$

V_{D} is the volume of the donor well, V_{A} is the volume of the acceptor well, Vₘₑₘ is the volume in the membrane, Area is the effective area of the membrane (0.24), time is the incubation time, [drug]_{A} is the concentration of drug that permeated into the acceptor well, and [drug]_{Eq} is the concentration of the drug in the system as if no membrane were present. [drug]_{Eq} is determined using the OD of the mass balance wells, which are solutions directly from the initial solubility filtrate plate.

Extinction Coefficient.

Compounds were solubilized in pH 7.4 phosphate buffer at 4 concentrations (175, 88, 44, and 22 μM) and then 75 μL was transferred to 384-well UV plates. UV spectra were measured from 250 to 550 nm. The appropriate wavelength (λ) was selected for each compound and then the OD value was used as input to Beer's law equation, A=ε(λ)·c·I. Where A is absorbance (OD), c is concentration and I is the path length. The pathlength for each well was determined using the PathCheck™ algorithm in the SoftMaxPro® software. Extinction coefficients at compound specific wavelengths, ε(λ), were then determined for each compound. The average ε from the 4 concentrations are reported in Table 1.

Results And Discussion

The purpose of integrating the solubility and permeability assays was to improve laboratory efficiency, reduce potential sources of systematic error, and to maximize sensitivity in the detection method. To demonstrate the benefits of this process flow, 8 control compounds were used. First, the solubility of these compounds was measured and compared to the data from literature. Secondly, effective permeability data are compared for the 8 control compounds assayed at 2 concentrations, at the solubility limit of each compound and at a fixed concentration. Assaying compounds for permeability at their solubility limit offers the following advantages: (i) no possibility of precipitate interfering with the membrane and membrane permeability determination (for the cases of precipitation, different calculation methods other than those presented in equations 2a and 2b may apply); (ii) the exact amount of compound in the system is known; (iii) improved sensitivity and reproducibility due to assaying at highest possible concentration of each compound. Finally, a larger set of compounds is used to create a compound ranking system for CNS activity and the new ranking system is compared to both in vitro and in vivo literature data.

Solubility. To test and validate the new solubility-permeability combination method, the following 8 control compounds were selected: caffeine, desipramine, diclofenac, phenazopyridine, piroxicam, propranolol, theophylline, and verapamil. These specific compounds were chosen because they are well characterized drugs in ADME literature, exemplify a range of Pₑ values, and represent some of the diversity that might be encountered in a lead discovery environment. Table 1 shows the solubility values that were determined along with the extinction coefficient (ε) at the relevant wavelength (λ). The coefficient of variation (CV) for each of the solubility values was on average 11% (n=5). Our data are in good agreement with the published data generated using similar solubility methods.

TABLE 1

| | pH | ε (M⁻¹cm⁻¹) [λ] | Solubility (μM) | Literature (μM) |
|---|---|---|---|---|
| Diclofenac | 3 | | 9 | |
| | 5 | | 18 | 30 |
| acid | 7.4 | 9900 [275 nm] | 274 | >350 |
| | 9 | | 324 | >350 |
| Theophylline | 3 | | 330 | |
| | 5 | | 337 | |
| acid | 7.4 | 10800 [270 nm] | 290 | >350 |
| | 9 | | >350 | |
| Piroxicam | 3 | | 55 | 32 |
| | 5 | | 66 | 32 |
| amorphous | 7.4 | 13100 [285 nm] | 257 | 300 |
| | 9 | | 336 | >350 |
| Caffeine | 3 | | 284 | |
| | 5 | | 291 | |
| neutral | 7.4 | 10100 [275 nm] | 265 | >350 |
| | 9 | | 350 | |
| Desipramine | 3 | | >350 | |
| | 5 | | >350 | |
| base | 7.4 | 6800 [275 nm] | >350 | 155 |
| | 9 | | >350 | |
| Phenazo- | 3 | | 332 | >350 |
| pyridine | 5 | | 89 | 150 |
| base | 7.4 | 8400 [430 nm] | 86 | 58 |
| | 9 | | 71 | 49 |
| Propranolol | 3 | | >350 | |
| | 5 | | >350 | |
| base | 7.4 | 5400 [290 nm] | >350 | 240 |
| | 9 | | >350 | |
| Verapamil | 3 | | >350 | |
| | 5 | | >350 | |
| base | 7.4 | 3400 [275 nm] | 333 | >350 |
| | 9 | | 141 | |

The pH-dependent solubility is demonstrated nicely with compounds such as diclofenac, phenazopyridine, piroxicam and verapamil. The solubility for diclofenac, a weak acid, increases with pH. The opposite trend is observed for the weak base, phenazopyridine. Determining the solubility for a range of gastrointestinal relevant pH values provides valuable data as to the total compound potentially available for absorption at the various locations in the gut.

Permeability.

To demonstrate the benefit of assaying compounds at their solubility limit, the effective permeability (Pₑ) was measured for the 8 control compounds in GIT- and BBB-PAMPA at 2 initial (t=0) donor well concentrations. For each compound, one input solution was an aliquot of the filtrate from the solubility assay and the other input solution was fixed at 100 μM. A fixed initial donor well concentration is general practice in most laboratories.

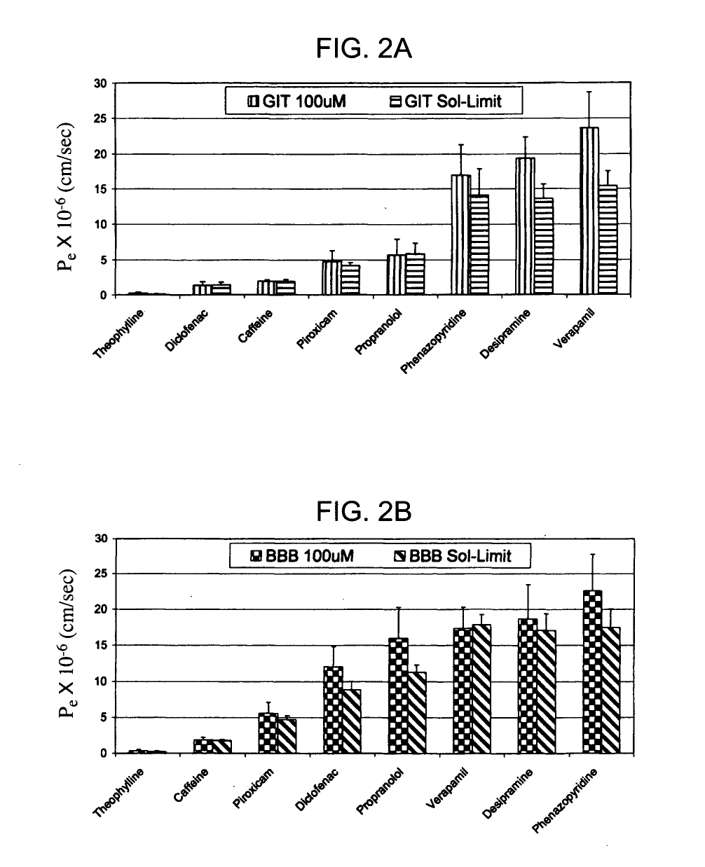

FIG. 2 shows the average Pₑ for 5 experiments plotted with standard deviations as error bars. In general, the Pₑ values obtained from the two different input concentrations agree within experimental error. More importantly, a significant reduction in the standard deviation of the average Pₑ is observed when compounds are assayed at their solubility limit versus at a fixed concentration of 100 μM. This effect is easily seen in the Pₑ values for both the GIT and BBB. By testing compounds at their solubility limit we maximize the amount of compound in solution and remove the possibility of precipitation in the donor compartment. When precipitation occurs in the donor well, a saturated solution is established for the entire permeation experiment, and therefore requires a different formula for calculation of Pₑ. By eliminating the possibility of precipitation, the use of equations 2a and 2b is maintained for all samples.

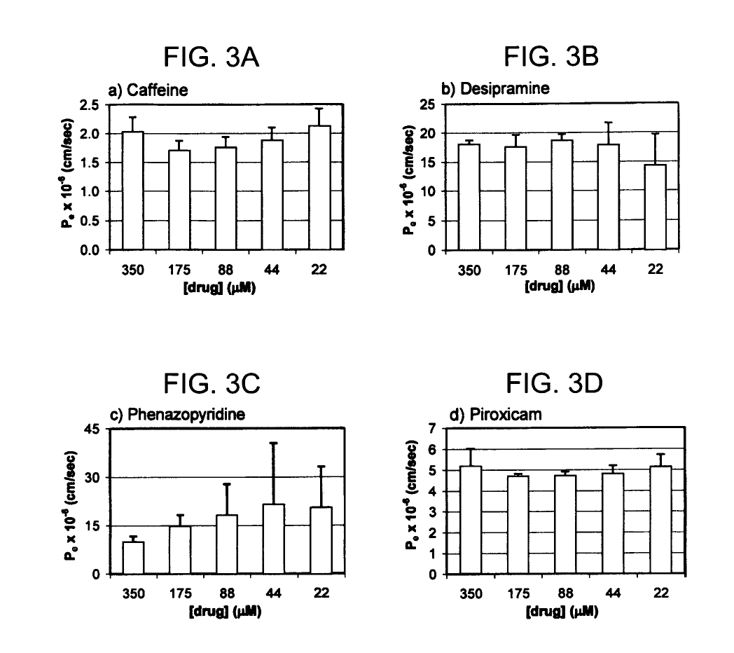

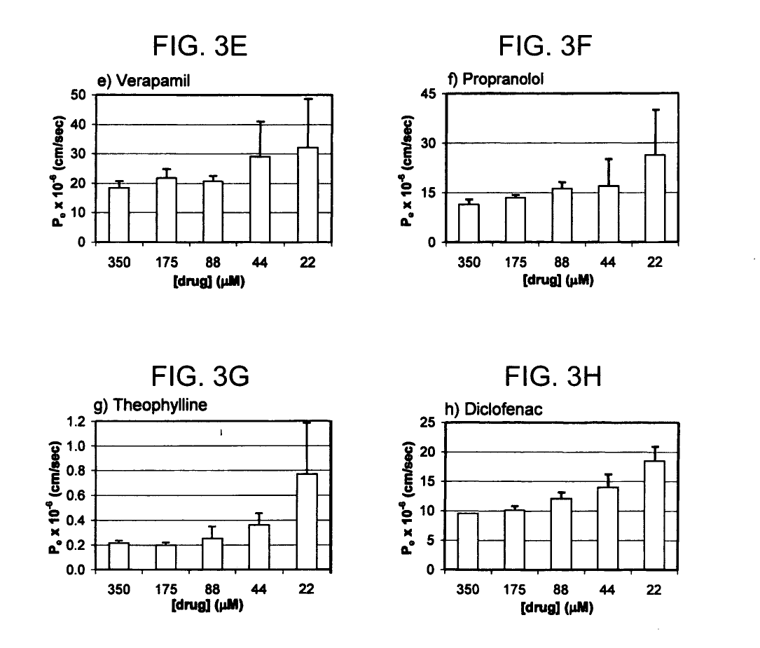

Because compound to compound solubility does vary, it is important to demonstrate that the Pₑ value measured at the solubility limit of each compound represents the true permeability of that compound. Theoretically, passive diffusion follows first-order rate kinetics and the initial rate constant of which, i.e. permeability, should not be dependent on compound input concentration. FIG. 3 is a graph of Pₑ versus input concentration measured using BBB-PAMPA for the 8 control compounds. The majority of the compounds (FIGS. 3a-e) show no dependence of Pₑ on concentration, within experimental error, in accordance with first order rate kinetics. The observed dependence of Pₑ on input concentration for a few compounds can be explained by compound detection limitations. At low input compound concentration, the experimental error becomes larger as a result of low absorbance values approaching the detection limit of the instrument. The reduction in detectable compound can be assigned to either low molar absorbance coefficient ε (propranonol, FIG. 3f ) or low Pₑ (theophylline, FIG. 3g). Diclofenac, FIG. 3h, is a highly permeable molecule (Pₑ≈10×10⁻⁶ cm/sec), and the observed Pₑ shows a slight (less than two-fold) but significant increase. Despite the deviation from the initial rate kinetics, this slight increase in Pₑ would not change our permeability ranking of these compounds.

According to Beers law, the measured optical density (OD) for each compound is dependent on the molar extinction coefficient (ε), concentration ([drug]), and pathlength (/). Therefore by assaying at the highest concentration possible (solubility limit), the reproducibility is improved as well as the probability of measuring a signal for every compound is increased. Also, testing compounds for permeability at their solubility limit is more representative of the situation in vivo than trying to artificially select a set concentration for each compound. The number of low soluble compounds is increasing and this technique would therefore benefit a larger number of compounds in drug discovery pipelines.

Inter/Intraplate Consistency and Throuqhput.

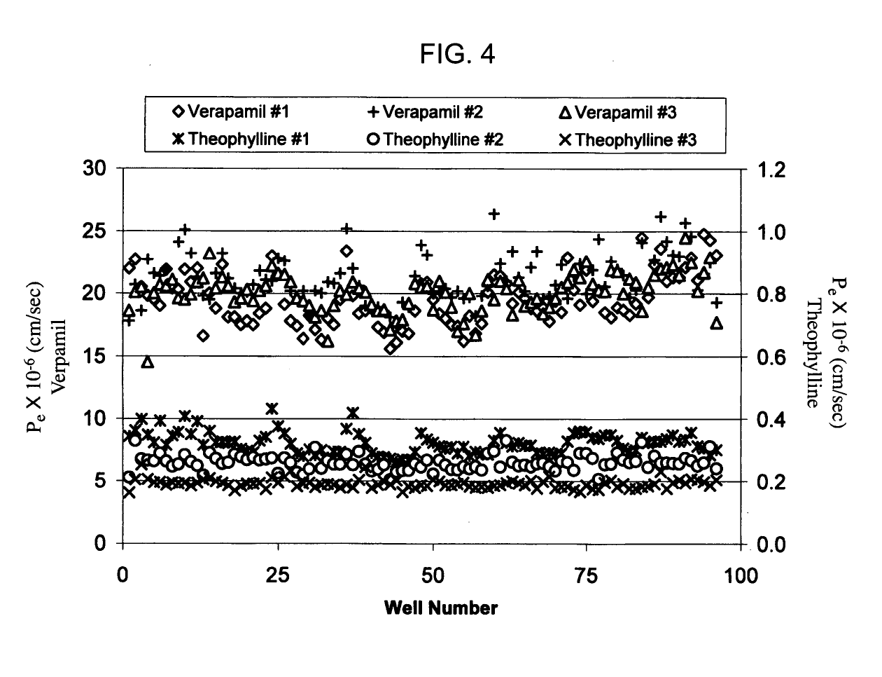

As a check of well-to-well and plate-to-plate variability within PAMPA, theophylline (low control) and verapamil (high control) were tested in each well of a 96-well plate. The experiment was set up on 3 different days and the results are plotted in FIG. 4. The well-to-well variability (CV) ranged from 8 to 11% for both the high and low controls. The magnitude of the standard deviations were 2.5×10⁻⁸ and 1.9×10⁻⁶ for theophylline and verapamil, respectively. The plate-to-plate variability (CV) for theophylline and verapamil were 26% and 4%, respectively. The % CV values for each compound are acceptable when considering the small absolute magnitude of the errors.

To maintain the demanding throughput required in today's drug discovery laboratories, a majority of the steps in the integrated solubility-permeability assay (Sol-PAMPA) have been automated (FIG. 1). With 1 MultiProbe, 1 Biomek FX96, 1 SpectraMaxPlus and 1 full-time employee, the maximum throughput for the solubility and permeability portions of the assay are 224 data points per day and 168 data points per 2 days, respectively. These numbers correlate to a full solubility and permeability profile of 56 compounds in 2 days. This throughput could be increased on demand by adding other liquid handling stations. The solubility plate format consists of 7 compounds being tested in duplicate at 4 pH conditions. The PAMPA plate format consists of 14 compounds being tested in the GIT model (two pH conditions: 5 to 7.4 and 7.4 to 7.4) and in the BBB model (one pH condition: 7.4 to 7.4). By including both permeation model membranes on a single PAMPA plate, compound handling (e.g., freeze thaw cycles) is further minimized.

The throughput of Sol-PAMPA has been increased compared to separate solubility and PAMPA assays due to the following reasons. First, the sample preparation from DMSO stock solutions for the permeability portion of the assay has been eliminated. By utilizing the filtrate of the solubility assay as input to PAMPA, the redundancy of creating similar aqueous solutions for each of the two individual assays is removed. The liquid handling steps involved in sample preparation, either by human or by robot, can be time consuming and can require large dead volumes of precious compound. By having only one of these steps in the process, time and compound usage (250 μg for a complete experiment) are minimized. Second, data analysis is streamlined by combining the process for both solubility and permeability into one analysis template. A substantial amount of time is required to enter compound information prior to analysis and upload for both the solubility and permeability assays. Therefore, by performing the calculations and data transfer in one template, it eliminates redundancy in the data entry of the same information. Third, because 384-well plates are used for UV/Vis spectral analysis four 96-well plates can be combined into a single analysis plate. For solubility, 28 compounds (7 compounds×4 plates) at 4 pH values are now analyzed in a single UV plate. For PAMPA, all of the necessary assay components (acceptor, donor, mass balance, and blanks) can now be read on a single plate for internal self-consistency and minimize plate-to-plate variability. Importantly, because 96- and 384-well UV plates are expensive, a substantial cost savings has been realized by using 384-well plates and thus reduce plate consumption. Overall, the above system improvements reduce plate reading time, plate handling and tracking problems, increase assay sensitivity and decrease cost.

Another benefit of using a 384- versus a 96-well plate is the increase in pathlength and hence higher optical density when equal sample volumes are used for concentration determination. The geometry of most plate readers used in absorption measurement is such that the light path through the sample is from the bottom of the well to the detector above the well. Therefore the height of the solution in the well dictates the pathlength. For a typical well in a 384-well plate, the pathlength through the solution is almost 3 times longer than for the same volume in a 96-well plate (0.66 cm vs. 0.23 cm for a 75 μl sample). Because absorbance is directly proportional to pathlength, the sensitivity is greatly improved by analyzing a set volume in the 384-well plate geometry.

Comparison with in Vivo Data.

The Sol-PAMPA method is set up to qualitatively rank compounds for bioavailability and CNS permeability. Here, we focus on the CNS predictability of the PAMPA-BBB model. In maintaining that focus, a set of 18 compounds with known in vivo CNS activity ranking was assembled as a test set for the combined method. This set of compounds is made up of some well known drug compounds as well as some that have been run in our laboratories (i.e., AGY-0064873 and AGY-0094806).

Table 2 shows solubility, BBB-PAMPA Pₑ, AGY ranking, and comparative CNS activity from the literature. One column contains a compound classification scheme for the PAMPA-BBB to predict BBB permeation that was established by Di et al, supra, where compounds with Pₑ>4.0×10⁻⁶ are classified as ‘CNS+’, and Pₑ<4.0×10⁻⁶ as ‘CNS-’. The ranking scheme employed in this report has been adjusted empirically to fit the experimental Pₑ data generated by this test set of compounds and then correlated to previously reported PAMPA-BBB and in vivo BBB permeation data.

In the Sol-PAMPA method, CNS+ compounds have a Pₑ>2.0×10⁻⁶ cm/sec and CNS- compounds have a Pₑ<2.0×10⁻⁶ cm/sec. Due to laboratory-to-laboratory variability it is recommended (see Di et al.), that the classification scheme be modified for each laboratory operation. In the test set presented here, caffeine is the only outlier. Caffeine is known to enter the brain by both passive diffusion and carrier mediated transport, and therefore PAMPA-BBB will underestimate the in vivo BBB permeability. With the slightly adjusted ranking scheme, the Pₑ data in this report are in good agreement with the literature PAMPA-BBB ranking and in vivo CNS permeability.

TABLE 2

| | pH 7.4 | | | | |
|---|---|---|---|---|---|
| | Solubility | Pₑ × 10⁻⁶ | AGY | In Vivo | [Brain]/ |
| Test Compound | (μM) | (cm/sec) | Ranking | CNS +/− | [Blood] |
| Ranitidine HCl | 174 | 0.02 | − | − | 0.06 |
| Lomafloxacin | 288 | 0.17 | − | − | |
| Isoxicam | 322 | 0.71 | − | − | |
| Loperamide | 165 | 1.07 | − | − | |
| Caffeine | 265 | 1.78 | − | + | 0.88 |
| Clonidine | 248 | 2.01 | + | + | 1.29 |
| AGY-0064873 | >350 | 2.73 | + | + | |
| Dextrophan | 300 | 3.14 | + | + | |
| SR-57227A | 294 | 6.12 | + | + | |
| MK-801 | 212 | 10.80 | + | + | |
| (dizocilpine) | | | | | |
| Zolantidine | 108 | 12.51 | + | + | 1.38 |
| Amitriptyline HCl | 163 | 12.77 | + | + | 9.55 |
| Carbamazepine | 253 | 12.91 | + | + | 1.00 |
| Fluvoxamine | 207 | 14.46 | + | + | |
| Quipazine | 239 | 14.88 | + | + | |
| AGY-0094806 | 146 | 16.10 | + | + | |
| Desipramine | 274 | 17.93 | + | + | 10.00 |
| N-tert-Butyl-a- | 270 | 23.13 | + | + | |
| phenylnitrone | | | | | |

Table 2: Solubility and effective BBB permeability (Pₑ) data for 19 test compounds. The compounds are ranked and compared to in vivo CNS activity and quantitative [Brain]/[Blood] ratios. With n=7 experiments, the solubility values had an average CV of 23% and the BBB-Sol-PAMPA Pₑ values had an average CV of 11%.

In Table 2, a column containing quantitative in vivo literature information for 8 of the compounds is included for comparison. This numerical data is derived from a rat model, which quantitates the ratio of concentrations of drug that permeates into the brain compared to that which remains in the blood (Kelder et al. (1999) Pharm Res 1999; 16:1514-1519). The correlation between the [Blood]/[Brain] numerical data and the Pₑ values generated by Sol-PAMPA BBB model is poor. However, the ranking as CNS+ or CNS− of these compounds does give an accurate representation of this quantitative information.

These data demonstrate the utility of an in vitro compound ranking system based on GIT- and BBB-PAMPA models. Equations 2a & b are sufficient for determining Pₑ to rank compounds for GIT and BBB activity.

Solubility and permeability are two critical parameters in the drug absorption process. As a natural extension from this principle, we have integrated the two assays to form the Sol-PAMPA process flow. The advantages of the combination method are: 1) reduction of sample usage and preparation time, 2) elimination of interference from compound precipitation in membrane permeability determination, 3) maximization of input concentration (solubility limit of each compound) to permeability assay for improved reproducibility, and 4) optimization of sample tracking by streamlining data entry and calculations. The data generated from Sol-PAMPA are in good agreement with current literature and BBB permeability ranking of compounds correlates well with literature CNS permeability.

1. A method for the combined determination of solubility and permeability of a compound, the method comprising:
performing a solubility assay and a permeability assay, wherein said permeability assay is performed using a filtrate from aqueous or cosolvent saturated solution obtained from said solubility assay, thereby providing each compound at a saturated, known concentration.

2. The method according to claim 1, wherein said solubility assay measures a spectrophotometric property of a saturated solution of said compound.

3. The method according to claim 2, wherein said solubility assay comprises:
preparing a sample solution of said compound in an aqueous buffer of known pH, and separating said sample solution from any precipitate to provide a filtrate,
preparing a reference solution that has a known concentration of said compound in said buffer, under conditions avoiding or suppressing precipitation,
preparing a blank solution free of said compound, but otherwise of the same composition as said reference solution,
measuring a spectrophotometric property of said sample filtrate, reference, and blank solutions;
determining the concentration of said sample solution by comparing the measured spectrophotometric property of said sample, reference and blank solutions, and calculating from said determination the aqueous solubility of said compound.

4. The method according to claim 3, wherein said plates are read with a UV/visible spectrophotometer.

5. The method according to claim 4, wherein the concentration of the compound in the solvent is determined by heuristically matching, scaling and background correcting the spectra and determining appropriate OD values to compare reference solutions to solutions containing an analyte of unknown concentration.

6. The method according to claim 1, wherein said permeability assay is a parallel artificial membrane permeation assay (PAMPA).

7. The method according to claim 6, wherein said permeability assay comprises:
placing an aliquot of said filtrate in a donor compartment;
covering said donor compartment with an artificial membrane barrier;
placing an initial acceptor solution in an acceptor compartment on the opposite side of said artificial membrane barrier;
preparing an acceptor-blank solution of the same composition as said initial acceptor solution
measuring an initial spectrophotometric property of said reference, donor-blank, and acceptor-blank solutions and measuring a spectrophotometric property of the final donor and final acceptor solutions after the start of the assay; and
determining the relative concentration of said final donor and acceptor solutions by comparing the measured spectrophotometric property of said final acceptor, final donor, reference, acceptor-blank and donor-blank solutions.

8. The method according to claim 7, wherein said artificial membrane barrier provides a gastrointestinal tract (GIT) model of phospholipid dissolved in organic solvent.

9. The method according to claim 7, wherein said artificial membrane barrier provides a blood brain barrier (BBB) model.

10. The method according to claim 9, wherein said artificial membrane comprises brain lipid extract dissolved in n-dodecane.

11. The method according to claim 1, wherein said assay is performed in a plate having 384 wells or greater than 384 wells.

12. A method for high-throughput spectrophotometric measurement of aqueous solubility and permeability of a test compound, the method comprising:
preparing a sample solution of said compound in an aqueous buffer of known pH, and separating said sample solution from any precipitate to provide a filtrate,
preparing a reference solution that has a known concentration of said compound in said buffer, under conditions avoiding or suppressing precipitation,
preparing a blank solution free of said compound, but otherwise of the same composition as said reference solution,
measuring a spectrophotometric property of said sample filtrate, reference, and blank solutions;
determining the concentration of said sample solution by comparing the measured spectrophotometric property of said sample, reference and blank solutions, and calculating from said determination the aqueous solubility of said compound
placing an aliquot of said filtrate in a donor compartment;
covering said donor compartment with an artificial membrane barrier;
placing an initial acceptor solution in an acceptor compartment on the opposite side of said artificial membrane barrier;
preparing an acceptor-blank solution of the same composition as said initial acceptor solution
measuring an initial spectrophotometric property of said reference, donor-blank, and acceptor-blank solutions and measuring a spectrophotometric property of the final donor and final acceptor solutions after the start of the assay; and
determining the relative concentration of said final donor and acceptor solutions by comparing the measured spectrophotometric property of said final acceptor, final donor, reference, acceptor-blank and donor-blank solutions.
